(19) United States
(12) Patent Application Publication
(10) Pub. No.: US 2004/0008685 A1
(43) Pub. Date: Jan. 15, 2004

(54) Multi-protocol label switching device and multi-protocol switching method

(75) Inventors: Satoru Yamano, Tokyo (JP); Satoshi Kinoshita, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/610,878

(22) Filed: Jul. 2, 2003

(30) Foreign Application Priority Data
Jul. 3, 2002 (JP) 2002-194049

(51) Int. Cl. H04L 12/28

(52) U.S. Cl. 370/395.5; 370/466

(57) ABSTRACT

An MPLS (Multi-Protocol Label Switching) device is provided which is capable of constructing a flexible network by using a wavelength path and an LSP (Label Switched Path) in combination. Each optical signal receiving section receives an optical signal having a corresponding wavelength out of optical signals having been divided for every wavelength by WDM (Wavelength Division Multiplexing) technology fed from node devices placed in a front stage and converts the received optical signal to an electrical signal. The converted electrical signal, after having undergone processing of a first layer (physical layer) and a second layer (data link layer) performed by a layer processing section and is then transferred to an MPLS switch section. The MPSL switch section determines an output port by performing a search for a database based on a value of a label of the received MPLS packet and, after having rewritten new contents into the label, transfers information about the determined output port to the layer processing section. A variable wavelength light signal transmitting section converts an electrical signal fed from each layer processing section to an optical signal having a designated wavelength and outputs it to a back stage.

### BACKGROUND OF THE INVENTION

1. Field of the Invention

The present invention relates to an MPLS (Multi-Protocol Label Switching) device and an MPLS method used in a Wavelength Division Multiplexing (WDM) communication system, and more particularly to the MPLS device and the MPLS method having a function/processing of a wavelength conversion.

The present application claims priority of Japanese Patent Application No. 2002-194049 filed on Jul. 3, 2002, which is hereby incorporated by reference.

2. Description of the Related Art

In recent years, in an access network connecting a carrier to a user, broadband communications have become widespread by a fulltime connection-type service including service using an xDSL (x Digital Subscriber Line) and an FTTH (Fiber To The Home) system, or a like.

Moreover, in a backbone network being a most important backbone, by using WDM (Wavelength Division Multiplexing) technology, an ultra-high-speed network for every wavelength can be constructed.

A common weakness in a network is a router and/or a switch which perform processing for every packet between the access network and the backbone network.

In the present WDM system, generally, a wavelength is assigned in a fixed manner and, when configurations of a network is changed due to addition of a WDM device, every time a path is changed, a manager of a network has to go to a site where a corresponding WDM device is placed and has to replace its card with new one, which presents a problem in that much time is taken and high costs are entailed.

### SUMMARY OF THE INVENTION

In view of the above, it is an object of the present invention to provide an MPLS device and an MPLS (Multi-Protocol Label Switching) method to be used in the MPLS device capable of using a wavelength path and an LSP (Label Switched Path) in combination and of constructing a flexible network.

According to a first aspect of the present invention, there is provided a Multi-Protocol Label Switching (MPLS) device used in a wavelength Division Multiplexing (WDM) communication system, the device including:

a plurality of optical signal receiving units, each of the optical signal receiving units to receive a Multi-Protocol Label Switching packet, as an optical signal having a wavelength being different from each other, via a corresponding input port of a plurality of input ports and to convert the received Multi-Protocol Label Switching packet as the optical signal to a Multi-Protocol Label Switching packet as an electrical signal;

a plurality of variable wavelength transmitting units, each of the variable wavelength transmitting units to select an arbitrary one wavelength out of a plurality of wavelengths being used in the Wavelength Division Multiplexing communication system;

a switching unit to be fed the converted Multi-Protocol Label Switching packet as the electrical signal from the optical signal receiving unit, and based on a value of a label of the converted Multi-Protocol Label Switching packet as the electrical signal, to determine an output port out of a plurality of output ports so as to output the Multi-Protocol Label Switching packet as the electrode signal to the variable wavelength transmitting unit, and;

wherein when the Multi-Protocol Label Switching packet as the electrical signal is fed from the switching unit to the variable wavelength transmitting unit, the variable wavelength transmitting unit converts the Multi-Protocol Label Switching packet as the electrical signal to the Multi-Protocol Label Switching packet as an optical signal having a predetermined wavelength and transmits the converted Multi-Protocol Label Switching packet as the optical signal.

In the foregoing first aspect, a preferable mode is one wherein the switching unit associates all Label Switched Paths (LSPs) in each of the input ports with each of the output ports in a one-to-one relationship and does switching from a specified input port to a specified output port associated therewith, and do switching in every input port.

By configuring as above, the packet can be transferred by using the wavelength path and the LSP in combination. When switching is done in every wavelength by associating all the LSPs in one input port with one output in the one-to-one relationship, an optical cross-connect function can be achieved.

Also, a preferable mode is one wherein the switching unit does switching for every Label Switched Path.

By doing switching in every LSP, since it is made possible to multiplex a plurality of the LSPs in every packet, a statistical multiplexing effect can be obtained.

Also, a preferable mode is one wherein the switching unit changes, by having the Label Switched Path transfer from a wavelength of an input light to a wavelength of an output light being different from the wavelength of the input light, a route of the Multi-Protocol Label Switching packet.

With this configuration, an effect of dispersing load can be obtained.

Also, a preferable mode is one wherein the switching unit is so configured to have the Label Switched Path transfer from the wavelength of the input light to the wavelength of the output light, by changing association of the input port with the output port.

Also, a preferable mode is one wherein the Label Switched Path transfers is so configured to transfer from the wavelength of the input light to the wavelength of the output light, a route of the Multi-Protocol Label Switching packet in by the variable wavelength transmitting unit, by which by the variable wavelength transmitting unit select the desirable wavelength of the output light.

Also, a preferable mode is one wherein the switching unit associates all Label Switched Paths (LSPs) in each of a plurality of input wavelength paths having input wavelength being different from each other with each of a plurality of output wavelength paths having output wavelength being different from each other in a one-to-one relationship and does switching from a specified input wavelength path to a specified output wavelength path associated therewith, and do switching in every input wavelength path.

Also, a preferable mode is one wherein the switching unit does switching for every Label Switched Path.

Also, a preferable mode is one wherein the switching unit changes, by having the Label Switched Path transfer from the input wavelength path having a wavelength of an input light to the output wavelength path having a wavelength of an output light being different from the wavelength of the input light, a route of the Multi-Protocol Label Switching packet.

Also, a preferable mode is one wherein the switching unit is so configured to have the Label Switched Path transfer from the input wavelength path having the wavelength of the input light to the output wavelength path having the wavelength of the output light, by changing association of the input wavelength path with the output wavelength path.

Also, a preferable mode is one wherein the Label Switched Path transfers is so configured to transfer from the output wavelength path having the wavelength of the input light to the output wavelength path having the wavelength of the output light, a route of the Multi-Protocol Label Switching packet in by the variable wavelength transmitting unit, by which by the variable wavelength transmitting unit select the desirable wavelength of the output light.

According to a second aspect of the present invention, there is provided a Multi-Protocol Label Switching (MPLS) method used in a Wavelength Division Multiplexing (WDM) communication system, the method including:

a step of receiving units to receive a Multi-Protocol Label Switching packet, as an optical signal having a wavelength being different from each other, via a corresponding input port of a plurality of input ports and converting the received Multi-Protocol Label Switching packet as the optical signal to a Multi-Protocol Label Switching packet as an electrical signal;

a step of determining an output port out of a plurality of output ports, based on a value of a label of the converted Multi-Protocol Label Switching packet as the electrical signal, and outputting the Multi-Protocol Label Switching packet as the electrode signal via the determined output port; and

a step of converting the Multi-Protocol Label Switching packet as the electrical signal fed via the determined output port to the Multi-Protocol Label Switching packet as an optical signal having a predetermined wavelength and transmitting the converted Multi-Protocol Label Switching packet as the optical signal.

In the foregoing second aspect, a preferable mode is one wherein all Label Switched Paths (LSPs) in each of the input ports. are associated with each of the output ports in a one-to-one relationship and does switching from a specified input port to a specified output port associated therewith, and do switching in every input port.

Also, a preferable mode is one wherein switching is done for every Label Switched Path.

Also, a preferable mode is one wherein by having the Label Switched Path transfer from a wavelength of an input light to a wavelength of an output light being different from the wavelength of the input light, a route of the Multi-Protocol Label Switching packet is changed.

Also, a preferable mode is one wherein switching is done to have the Label Switched Path transfer from the wavelength of the input light to the wavelength of the output light, by changing association of the input port with the output port.

Also, a preferable mode is one wherein all Label Switched Paths (LSPs) in each of a plurality of input wavelength paths having input wavelength being different from each other are associated with each of a plurality of output wavelength paths having output wavelength being different from each other in a one-to-one relationship and does switching from a specified input wavelength path to a specified output wavelength path associated therewith, and switching is done for every input wavelength path.

Also, a preferable mode is one wherein switching is done for every Label Switched Path.

Also, a preferable mode is one wherein by having the Label Switched Path transfer from the input wavelength path having a wavelength of an input light to the output wavelength path having a wavelength of an output light being different from the wavelength of the input light, a route of the Multi-Protocol Label Switching packet is changed.

Also, a preferable mode is one wherein switching is done to have the Label Switched Path transfer from the input wavelength path having the wavelength of the input light to the output wavelength path having the wavelength of the output light, by changing association of the input wavelength path with the output wavelength path.

With the above configurations, in the MPLS device having a plurality of optical signal receiving units, each of which can receive an optical signal having wavelength being different from each other for every input port, a switching unit which determines, after having converted the optical signal to the electrical signal, the output route based on the value of the label of the MPLS packet and a variable wavelength light signal transmitting unit which can select an arbitrary one wavelength out of wavelengths to be used in a WDM method in every output port, since the above variable wavelength light signal transmitting unit converts the MPLS packet transferred by the output port to the optical signal having the wavelength and then transmits the converted signal, the wavelength path and the LSP can be used in combination, thus enabling a flexible network to be constructed.

With still another configuration as above, since the WDM technology is applied to the router or the switch, the conventional bottleneck in the network can be eliminated.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing configurations of an MPLS device according to an embodiment of the present invention;

FIG. 2 is a schematic block diagram showing an example of configurations of a network using the MPLS device of the embodiment of the present invention;

FIG. 3 is a diagram showing a relationship between a wavelength path and an LSP according to the embodiment of the present invention;

FIG. 4 is a diagram illustrating an example of a state in which a wavelength path is switched according to the embodiment of the present invention;

FIG. 5 is a diagram illustrating an example of a state in which the wavelength path is changed according to the embodiment of the present invention;

FIG. 6 is a diagram illustrating an example of a state in which the LSP is switched according to the embodiment of the present invention; and

FIG. 7 is a diagram illustrating an example of a state in which the LSP is changed according to the embodiment of the present invention;

### DETAILED DESCRIPTION OF THE PREFERRED EMBODIMENTS

Best modes of carrying out the present invention will be described in further detail using various embodiments with reference to the accompanying drawings.

### Embodiment

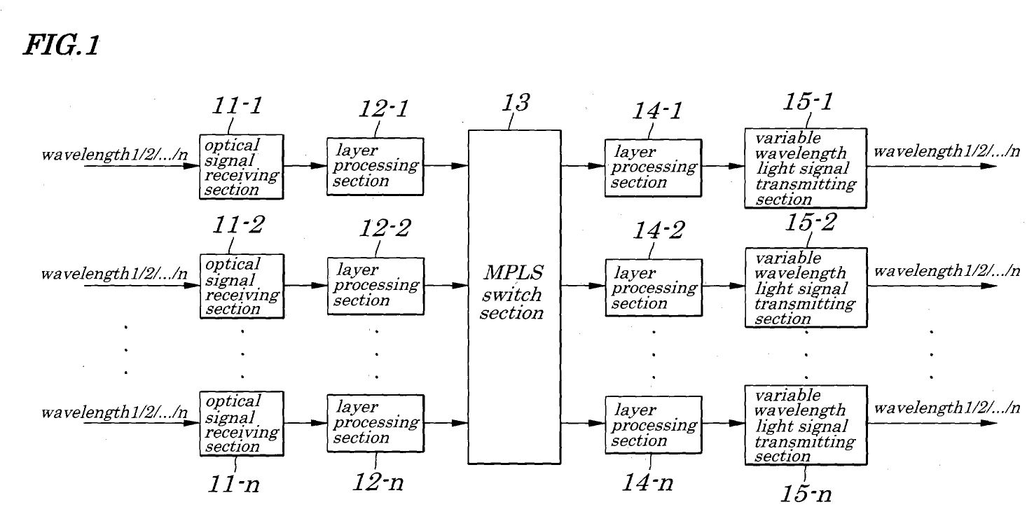

FIG. 1 is a schematic block diagram showing configurations of an MPLS device according to an embodiment of the present invention. As shown in FIG. 1, the MPLS (Multi-Protocol Label Switching) device of the embodiment of the present invention includes optical signal receiving sections 11 (11-1 to 11-n), layer processing sections 12-1 to 12-n, an MPLS switch section 13, layer processing sections 14-1 to 14-n, and variable wavelength light signal transmitting sections 15 (15-1 to 15n)

Each of the optical signal receiving sections 11-1 to 11-n receives an optical signal having a corresponding wavelength out of optical signals having been divided for every wavelength by a WDM (Wavelength Division Multiplexing) signal fed from node devices such as a router, switch, or a like (not shown) placed in a front stage and converts the received optical signal to an electrical signal. The converted electrical signal, after having undergone processing of a first layer (physical layer) and a second layer (data link layer) performed by the layer processing sections 12-1 to 12-n, is transferred to the MPLS switch section 13.

The MPSL switch section 13 is provided with a database (not shown) in which both data on association of an input port (a wavelength of input light) with an output port (a wavelength of output light) for every path in the MPLS device and a label for replacement are stored and selects an output port by performing a search for a database based on a value of a label of the received MPLS packet and, after having rewritten new contents into the label, transfers information about the selected output port to the layer processing sections 14-1 to 14-n of a corresponding output port.

The variable wavelength light signal transmitting section 15-1 to 15-n converts an electrical signal fed from each of the layer processing sections 14-1 to 14-n to an optical signal having a designated wavelength and outputs the converted signal to a back stage. The variable wavelength light signal transmitting section 15-1 to 15-n can select an arbitrary one wavelength out of wavelengths to be used in the WDM technology and can change a wavelength by setting. As a final step, a plurality of optical signals is multiplexed to produce WDM signals and then is transmitted to node devices such as the router, switch or the like placed in a next stage.

Protocols that function by the second layer (data link layer) employed in the layer processing sections 12-1 to 12-n includes a protocol for Ethernet (R), a protocol for an ATM (Asynchronous Transfer Mode), a PPP (Point-to-Point Protocol), or a like.

A wavelength is changed when a route used to transfer a packet is added, deleted, or changed. Particularly, the wavelength is used in service in which an LSP (Label Switched Path) is leased to a user as a leased line. A wavelength to be used by each switch has to be determined in an entire network by taking a combination of a transmitter of a path to be placed and destination, and an amount of traffic into consideration.

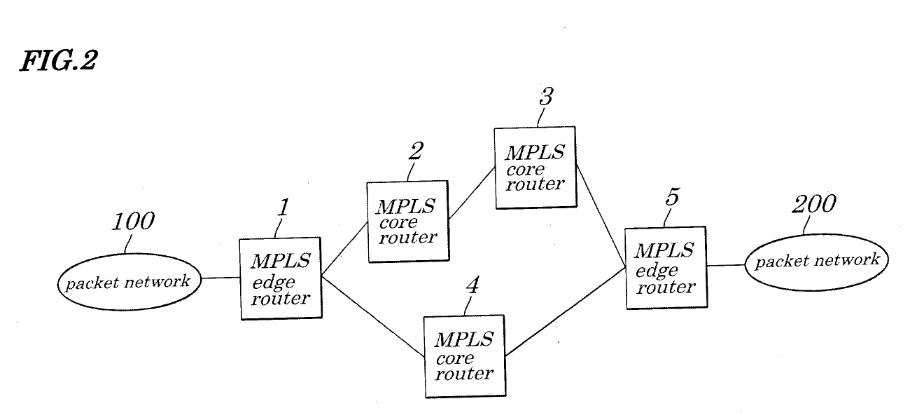

FIG. 2 is a schematic block diagram showing an example of configurations of a network using the MPLS device of the embodiment of the present invention. In FIG. 2, each of MPLS edge routers 1 and 5 add an MPLS header containing a label serving as destination information to a packet being received from packet networks 100 and 200 and transfers an MPLS packet to MPLS core routers 2 to 4 placed in a back stage.

The MPLS core routers 2 to 4 do switching of the MPLS packet based on label information about the MPLS header and put a new label on the MPLS packet and then transfers it to a router placed in the back stage.

The edge routers 1 and 5 receiving the MPLS packet delete the MPLS header and transmit the packet to the packet networks 100 and 200. Thus, by placing the LSP serving as an MPLS path in a virtual manner between the MPLS edge routers 1 and 5, transfer of the packet is achieved. According to the embodiment of the present invention, the MPLS device is realized which has a function of converting a wavelength achieved by incorporating the WDM technology into functions of the MPLS core routers 2 to 4.

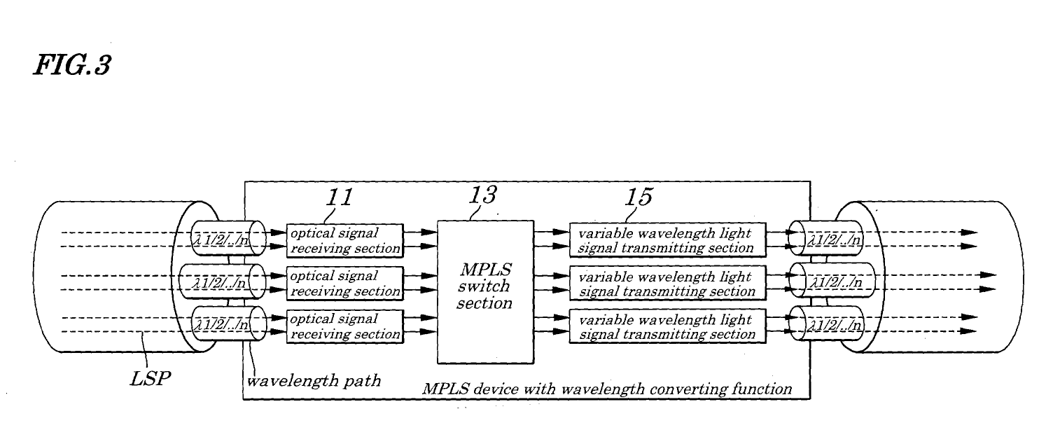

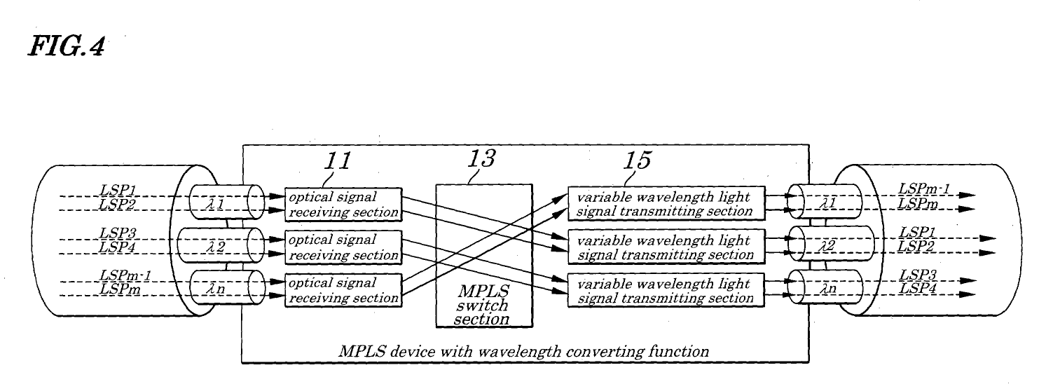

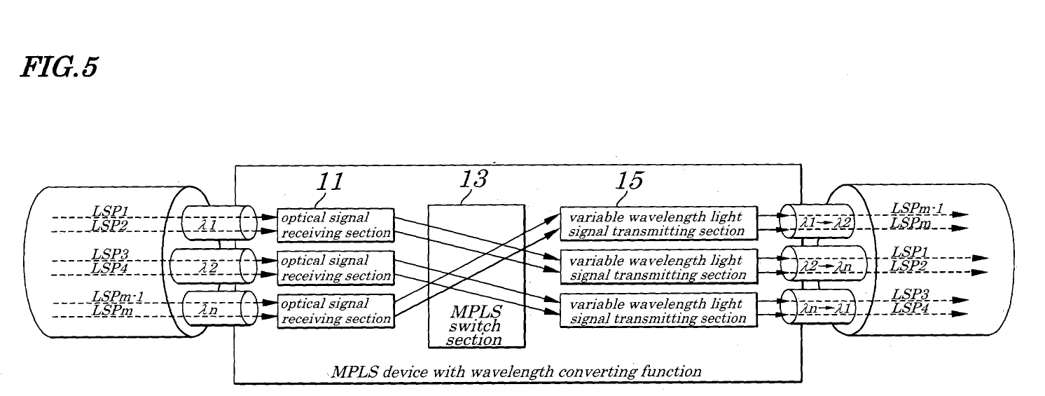

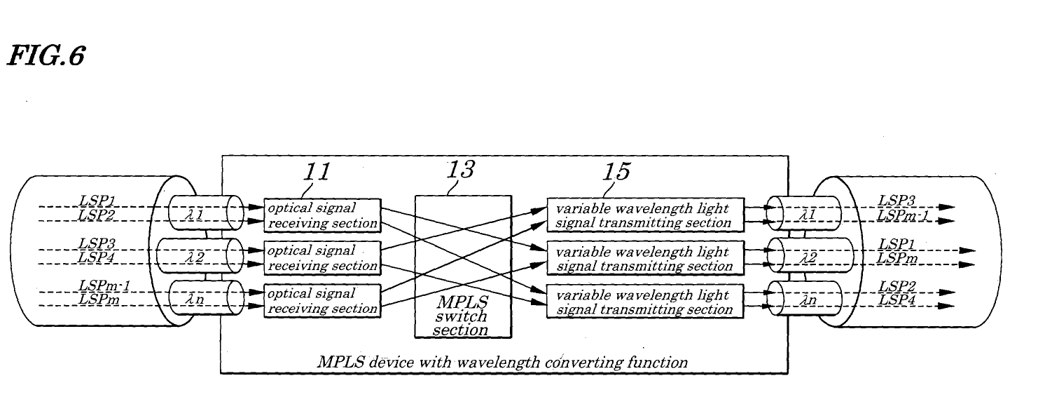

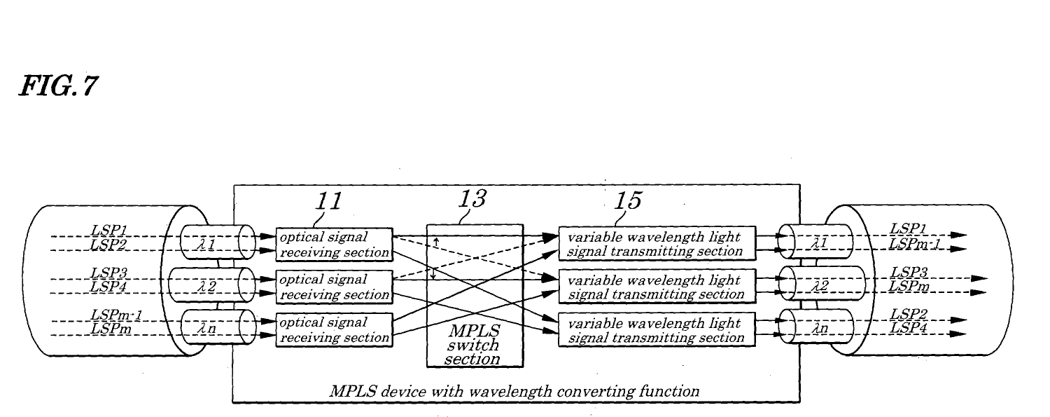

FIG. 3 is a diagram showing a relationship between a wavelength path and the LSP according to the embodiment of the present invention. FIG. 4 is a diagram illustrating an example of a state in which the wavelength path is switched according to the embodiment of the present invention. FIG. 5 is a diagram illustrating an example of a state in which the wavelength path is changed according to the embodiment of the present invention. FIG. 6 is a diagram illustrating an example of a state in which the LSP is switched according to the embodiment of the present invention. FIG. 7 is a diagram illustrating an example of a state in which the LSP is changed according to the embodiment of the present invention. Operations of the MPLS device of the embodiment of the present invention are described by referring to FIG. 1 to FIG. 7.

In the MPLS device method using a function of converting a wavelength, by combining the wavelength path and the LSP, switching of the wavelength path and an LSP path can be achieved. FIG. 3 shows a relationship between the wavelength path and the LSP during operations of the MPLS device having a function of converting the wavelength. As shown in FIG. 3, a plurality of LSPs is set in the wavelength path.

In order to achieve switching of the wavelength path, association of a wavelength of input light (hereinafter may be referred to as input wavelength) with a wavelength of output light (hereinafter may be referred to as output wavelength) for every port is required. In the example of switching of a wavelength path shown in FIG. 4, allotment is made so that an LSP1 (a first Label Switched Path) and an LSP2 (a second Label Switched Path) are transmitted via a wavelength path having an input wavelength λ1, an LSP3 (a third Label Switched Path) and an LSP4 (a fourth Label Switched Path) are transmitted via a wavelength path having an input wavelength λ2 and an LSPₘ₋₁ (an “m−1”th Label Switched Path) and an LSPₘ (an “m”th Label Switched Path) are transmitted via a wavelength path having an input wavelength λn, and that the LSPₘ₋₁ and LSPₘ are associated with a wavelength path having an output wavelengths λ1, the LSP1 and LSP2 are associated with a wavelength path having an output wavelength λ2, and the LSP3 and LSP4 are associated with a wavelength path having an output wavelength λn.

As shown in FIG. 4, the input wavelength λ1 is mapped onto the output wavelength λ2, the input wavelength λ2 is mapped onto the output wavelength λn, and the input wavelength λn is mapped onto the output wavelength λ1. To achieve this mapping, it is preferable to associate all LSPs in one input port (input wavelength) with one output port (output wavelength) in a one-to-one relationship.

When the input wavelength λ1 is mapped onto the output wavelength λ2, the MPLS switch section 13 has the LSP1 and LSP2 transfer from the input carrier of the wavelength λ1 to the output carrier of the wavelength λ2 by its switching operation.

When the input wavelength λ2 is mapped onto the output wavelength λn, the MPLS switch section 13 has the LSP3 and LSP4 transfer from the input carrier of the wavelength λ2 to the output carrier of the wavelength λn by its switching operation.

When the input wavelength λn is mapped onto the output wavelength λ1, the MPLS switch section 13 has the LSPₘ₋₁ and LSPₘ transfer from the input carrier of the wavelength λn to the output carrier of the wavelength λ1 by its switching operation. Thus, optical cross-connect function can be achieved.

Moreover, by changing an output port (an output wavelength) corresponding to all the LSPs being carried by an input wavelength via each of input ports, that is, by changing association of an input port with an output port in the MPLS switch section 13, a wavelength path can be changed, which enables a route to be switched for packet transfer in every wavelength.

Furthermore, in order to change a wavelength path by another method, a wavelength of an optical signal is changed in the variable wavelength light signal transmitting section 15. In the example shown in FIG. 5, an output wavelength is changed from λ1 to λ2, from λ2 to λn, from λn to λ1. Thus, it is possible to change a wavelength by changing a wavelength -in the variable wavelength light signal transmitting section 15.

To achieve switching of an LSP, association of an input wavelength with an output wavelength for every LSP is required. To do this, it is necessary that an LSP in an input port (an input wavelength) is associated with an output port (an output wavelength) in a one-to-one relationship in the MPLS switch section 13. FIG. 6 shows an example of switching of the LSP.

Here, as shown in FIG. 6, allotment is made so that an LSP1 and an LSP2 are transmitted via a wavelength path having an input wavelength λ1, an LSP3 and an LSP4 transmitted via a wavelength path having an input wavelength λ2 and the LSPₘ₋₁ and the LSPₘ are transmitted via a wavelength path having an input wavelength λn, and that the LSP₃ and LSPₘ₋₁ are associated with a wavelength path having an output wavelength λ1, the LSP₁ and LSPₘ are associated with a wavelength path having an output wavelength λ2, and the LSP₂ and LSP₄ are associated with a wavelength path having an output wavelength λn.

In the example shown in FIG. 6, the LSP1 is mapped onto an input wavelength λ1 and an output wavelength λ2, the LSP2 is mapped onto an input wavelength λ1 and an output wavelength λn, the LSP3 is mapped onto an input wavelengths λ2 and an input wavelength λ1, the LSP4 is mapped onto an input wavelength λ2 and an output wavelength λn, the LSPₘ₋₁ is mapped onto an input wavelength λn and an output wavelength λ1, and the LSPₘ is mapped onto an input wavelength λn and an output wavelength λ2. Thus, by multiplexing an MPLS packet for every packet, an statistical multiplexing effect can be obtained for every wavelength.

Moreover, a route of an LSP can be changed only by changing data on association of an input port (input wavelength) and an output port (output wavelength) of a corresponding LSP and a label for replacement of the input port (input wavelength) with the output port (output wavelength). In the example shown in FIG. 7, an output wavelength of the LSP1 is changed from λ2 to λ1 and an output wavelength of the LSP3 is changed from λ1 to λ2. It is therefore possible to disperse load of transferring a packet for every wavelength by changing the route of the LSP.

Thus, according to the embodiment of the present invention, by operating the MPLS device having such the function of changing the wavelength as described above, it is made possible to construct a flexible network.

As described above, according to the present invention, since all the LSPs in one input port (an input wavelength) are associated with one output port (an output wavelength) in a one-to-one relationship, by switching the wavelength path, an optical cross-connect function can be achieved.

Moreover, according to the present invention, by changing association of the input port with the output port or by changing the wavelength in the variable wavelength light signal transmitting section 15, the wavelength path can be changed.

Also, according to the present invention, since the plurality of LSPs is multiplexed for every packet, by doing switching using the LSP, statistical multiplexing effects can be obtained in every wavelength.

Furthermore, according to the present invention, since the output wavelength is changed by changing the route of the LSP, load of transferring the packet can be dispersed in every wavelength.

As described above, since the wavelength path and the LSP can be used in combination in the MPLS device of the present invention, it is possible to construct a flexible network. Moreover, the present invention can be applied not only to the MPLS method but also to a GMPLS (Generalized Multi-Protocol Label Switching) method in which a wavelength is used as a label in an optical network.

It is apparent that the present invention is not limited to the above embodiments but may be changed and modified without departing from the scope and spirit of the invention.

What is claimed is:

1. A Multi-Protocol Label Switching (MPLS) device used in a Wavelength Division Multiplexing (WDM) communication system, the device comprising:
a plurality of optical signal receiving units, each of said optical signal receiving units to receive a Multi-Protocol Label Switching packet, as an optical signal having a wavelength being different from each other, via a corresponding input port of a plurality of input ports and to convert the received Multi-Protocol Label Switching packet as said optical signal to a Multi-Protocol Label Switching packet as an electrical signal;
a plurality of variable wavelength transmitting units, each of said variable wavelength transmitting units to select an arbitrary one wavelength out of a plurality of wavelengths being used in the Wavelength Division Multiplexing communication system;
a switching unit to be fed the converted Multi-Protocol Label Switching packet as said electrical signal from said optical signal receiving unit, and based on a value of a label of the converted Multi-Protocol Label Switching packet as said electrical signal, to determine an output port out of a plurality of output ports so as to output said Multi-Protocol Label Switching packet as said electrode signal to said variable wavelength transmitting unit, and;
wherein when said Multi-Protocol Label Switching packet as said electrical signal is fed from said switching unit to said variable wavelength transmitting unit, said variable wavelength transmitting unit converts said Multi-Protocol Label Switching packet as said electrical signal to said Multi-Protocol Label Switching packet as an optical signal having a predetermined wavelength and transmits the converted Multi-Protocol Label Switching packet as said optical signal.

2. The Multi-Protocol Label Switching device according to claim 1, wherein said switching unit associates all Label Switched Paths (LSPs) in each of said input ports with each of said output ports in a one-to-one relationship and does switching from a specified input port to a specified output port associated therewith, and do switching in every input port.

3. The Multi-Protocol Label Switching device according to claim 2, wherein said switching unit does switching for every Label Switched Path.

4. The Multi-Protocol Label Switching device according to claim 2, wherein said switching unit changes, by having said Label Switched Path transfer from a wavelength of an input light to a wavelength of an output light being different from said wavelength of said input light, a route of said Multi-Protocol Label Switching packet.

5. The Multi-Protocol Label Switching device according to claim 4, wherein said switching unit is so configured to have said Label Switched Path transfer from said wavelength of said input light to said wavelength of said output light, by changing association of said input port with said output port.

6. The Multi-Protocol Label Switching device according to claim 4, wherein said Label Switched Path transfers is so configured to transfer from said wavelength of said input light to said wavelength of said output light, a route of said Multi-Protocol Label Switching packet in by said variable wavelength transmitting unit, by which by said variable wavelength transmitting unit select the desirable wavelength of said output light.

7. The Multi-Protocol Label Switching device according to claim 1, wherein said switching unit associates all Label Switched Paths (LSPs) in each of a plurality of input wavelength paths having input wavelength being different from each other with each of a plurality of output wavelength paths having output wavelength being different from each other in a one-to-one relationship and does switching from a specified input wavelength path to a specified output wavelength path associated therewith, and do switching in every input wavelength path.

8. The Multi-Protocol Label Switching device according to claim 7, wherein said switching unit does switching for every Label Switched Path.

9. The Multi-Protocol Label Switching device according to claim 7, wherein said switching unit changes, by having said Label Switched Path transfer from said input wavelength path having a wavelength of an input light to said output wavelength path having a wavelength of an output light being different from said wavelength of said input light, a route of said Multi-Protocol Label Switching packet.

10. The Multi-Protocol, Label Switching device according to claim 9, wherein said switching unit is so configured to have said Label Switched Path transfer from said input wavelength path having said wavelength of said input light to said output wavelength path having said wavelength of said output light, by changing association of said input wavelength path with said output wavelength path.

11. The Multi-Protocol Label Switching device according to claim 9, wherein said Label Switched Path transfers is so configured to transfer from said output wavelength path having said wavelength of said input light to said output wavelength path having said wavelength of said output light, a route of said Multi-Protocol Label Switching packet in by said variable wavelength transmitting unit, by which by said variable wavelength transmitting unit select the desirable wavelength of said output light.

12. A Multi-Protocol Label Switching (MPLS) method used in a Wavelength Division Multiplexing (WDM) communication system, the method comprising:
a step of receiving units to receive a Multi-Protocol Label Switching packet, as an optical signal having a wavelength being different from each others via a corresponding input port of a plurality of input ports and converting the received Multi-Protocol Label Switching packet as said optical signal to a Multi-Protocol Label Switching packet as an electrical signal;
a step of determining an output port out of a plurality of output ports, based on a value of a label of the converted Multi-Protocol Label Switching packet as said electrical signal, and outputting said Multi-Protocol Label Switching packet as said electrode signal via the determined output port; and
a step of converting said Multi-Protocol Label Switching packet as said electrical signal fed via said determined output port to said Multi-Protocol Label Switching packet as an optical signal having a predetermined wavelength and transmitting the converted Multi-Protocol Label Switching packet as said optical signal.

13. The Multi-Protocol Label Switching method according to claim 12, wherein all Label Switched Paths (LSPs) in each of said input ports are associated with each of said output ports in a one-to-one relationship and does switching from a specified input port to a specified output port associated therewith, and do switching in every input port.

14. The Multi-Protocol Label Switching device according to claim 13, wherein switching is done for every Label Switched Path.

15. The Multi-Protocol Label Switching device according to claim 13, wherein by having said Label Switched Path transfer from a wavelength of an input light to a wavelength of an output light being different from said wavelength of said input light, a route of said Multi-Protocol Label Switching packet is changed.

16. The Multi-Protocol Label Switching device according to claim 15, wherein switching is done to have said Label Switched Path transfer from said wavelength of said input light to said wavelength of said output light, by changing association of said input port with said output port.

17. The Multi-Protocol Label Switching device according to claim 12, wherein all Label Switched Paths (LSPs) in each of a plurality of input wavelength paths having input wavelength being different from each other are associated with each of a plurality of output wavelength paths having output wavelength being different from each other in a one-to-one relationship and does switching from a specified input wavelength path to a specified output wavelength path associated therewith, and switching is done for every input wavelength path.

18. The Multi-Protocol Label Switching device according to claim 17, wherein switching is done for every Label Switched Path.

19. The Multi-Protocol Label Switching device according to claim 17, wherein by having said Label Switched Path transfer from said input wavelength path having a wavelength of an input light to said output wavelength path having a wavelength of an output light being different from said wavelength of said input light, a route of said Multi-Protocol Label Switching packet is changed.

20. The Multi-Protocol Label Switching device according to claim 19, wherein switching is done to have said Label Switched Path transfer from said input wavelength path having said wavelength of said input light to said output wavelength path having said wavelength of said output light, by changing association of said input wavelength path with said output wavelength path.
